(19) United States
(12) Patent Application Publication
(10) Pub. No.: US 2001/0018340 A1
(43) Pub. Date: Aug. 30, 2001

(54) System for providing information within certain area in accordance with attribute of people located therein

(75) Inventor: Minoru Tagi, Tokyo (JP)

Correspondence Address: Frishauf, Holtz, Goodman, Langer & Chick, P.C., 25th Floor, 767 Third Avenue, New York, NY, 10017-2023, US

(73) Assignee: Casio Computer Co., Ltd., Tokyo (JP)

(21) Appl. No.: 09/793,482

(22) Filed: Feb. 26, 2001

(30) Foreign Application Priority Data
Feb. 29, 2000 (JP) 2000-053652

(51) Int. Cl. H04M 3/42; H04Q 7/20; H04B 1/38

(52) U.S. Cl. 455/414; 455/435; 455/566

(57) ABSTRACT

The base station control center controls the terminal located in the communication area and stores the attribute data of the terminal owner. The advertising units are installed at street corners and athletic fields where many people gather. The control center checks the terminal located in the area where the advertising units are placed, and after analyzing the attribute information of the people in the area, provide them to the advertisement server. The advertisement server receives the advertisement contents together with the advertisement target conditions. When the advertisement server receives the analysis results of the attribute information of the people in the area, the advertisement contents corresponding to the advertisement target conditions are selected, and provided to the mobile type advertisement unit or the fixed type advertisement unit.

### CROSS-REFERENCE TO RELATED APPLICATIONS

This application is based upon and claims the benefit of priority from the prior Japanese Patent Application No. 2000-053652, filed Feb. 29, 2000, the entire contents of which are incorporated herein by reference.

### BACKGROUND OF THE INVENTION

The present invention relates to a system for effectively providing information, such as advertisements, to be seen by people.

In recent years, as one of the mobile communication systems, in Japan, the PHS (personal handy-phone system) that adopts small communication areas (small zones) having a radius of several hundred meters for each base station is put to practical use. As an application of this system, since the communication area of one base station is rather small, a system for providing information restricted to a certain area to the PHS terminal inside of the communication area covered by the base station has been considered.

However, in the case of such an information providing system, the information is merely provided according to the request of the information provider, and the information is provided regardless of what kind of people located in the communication area at that time. Therefore, even if information regarding publicity and advertisement is provided, if people having no interest in the contents of the advertisement is located in the area, there is no advertisement effect, and the efficiency of publicity and advertisement is extremely bad.

### BRIEF SUMMARY OF THE INVENTION

Accordingly, it is an object of the present invention to provide an information providing system which investigates what sort of people located in a certain area, selects information in accordance with the attributes of the people, and provides the selected information, thus effectively providing advertisements.

According to the present invention, there is provided an information providing system for providing information to a display device located in a specified area, the system comprising a memory configured to store a plurality of items of information; an analyzer configured to analyze information related to a user of a mobile terminal located in the specified area; a selector configured to select an item or items of information among the plurality of items of information stored in the memory based on a result of analyzing by the analyzer; and a providing circuit configured to provide the item or items of information selected by the selector to the display device.

The display device may comprise a screen which is installed to public places so that many and unspecified people can see.

The system may further comprises a database configured to store user information containing at least a distinction of sex, age, and occupation of the user; an identification circuit configured to identify the mobile terminal located in the specified area; and a fetching circuit configured to fetch the user information of the user of the mobile terminal identified by the identification circuit from the database, and wherein the analyzer may statistically analyze the user information fetched by the fetching circuit.

It is preferable that the provided information is advertisement information.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a block diagram showing the configuration of an embodiment of the advertisement providing system according to the present invention;

FIG. 2 is a block diagram showing the configuration of the advertisement server;

FIG. 3 shows an example of data (member database) controlled by the base station control center;

FIG. 4 is a diagram showing an example of the controlled data (terminal control (position registration) database) by the base station control center;

FIG. 5 shows an example of the contents control database controlled by the advertisement server;

FIG. 6 shows an example of advertisement data controlled by the advertisement server;

FIG. 7 shows an example of advertisement effect control database controlled by the advertisement server;

FIG. 8 is a flow chart showing area information preparation processing in the base station control center;

FIG. 9 is a flow chart of area information output request processing in the advertisement server accompanying the advertisement transmission based on the advertisement server;

FIG. 10 is a flow chart showing the area information output processing in the base station control center;

FIG. 11 is a flow chart showing account processing in the advertisement server;

FIG. 12 shows the flow of information in each section included in the system;

FIG. 13 shows appearance configuration of the terminal;

FIG. 14 shows a flow chart of individual advertisement processing in the advertisement server;

FIG. 15 shows the flow of information in each section included in the system;

FIG. 16 is a flow chart showing additional advertisement processing in the advertisement server; and

FIG. 17 shows an example of the contents displayed on the advertisement screen.

### DETAILED DESCRIPTION OF THE INVENTION

A preferred embodiment of an information providing system according to the present invention will now be described with reference to the accompanying drawings.

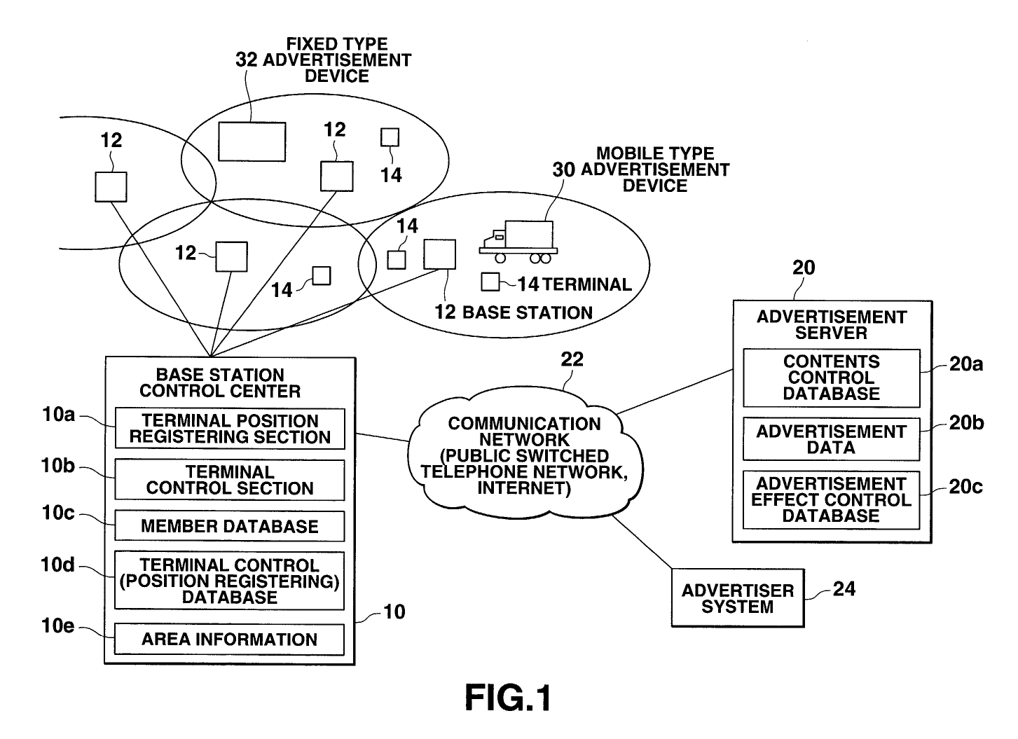

FIG. 1 is a block diagram showing the configuration of the embodiment applying the information providing system of the present invention to the advertisement providing system. As shown in FIG. 1, the advertising system in the present embodiment comprises a base station control center 10, a plurality of base stations 12, a plurality of terminals 14, an advertisement server 20 (information providing device), a communication network 22, an advertiser system 24, a mobile type advertisement device 30, a fixed type advertisement device 32, etc.

The base station control center 10 that controls the terminal 14 via the base stations 12 controls the plurality of base stations 12, and controls radio communications performed among the base stations 12 as well as communications performed among other communication equipment via the terminal 14 and the communication network 22. The communication system of the present embodiment utilizes, for example, the radio telephone system of small zones such as the PHS (personal handy-phone system) that has been put into practical use in Japan, and it is assumed that the base station control center 10 always detects in which control area (communication area) of the base station the terminal 14 is located. This is called the position registering function of the radio telephone system. The base station control center 10 is formed of a computer system, and maintenances (stores or updates) the member database 10c, terminal control (position registering) database 10d, and area information 10e in addition to realize the functions of a terminal position registering section 10a and terminal control section 10b by computer processing.

The terminal position registering section 10a controls the registering process of terminal 14 located in the communication area of each base station 12 to terminal control (position registering) database 10d.

The terminal control section 10b analyzes the information of the terminal 14 registered in the terminal control (position registering) database 10d, and the advertisement server 20 controls processing for preparing area information that is utilized for transmitting advertisement to specified intended parties. The area information is the information related to the user of the terminal located in a specified area, for example, profile data showing the profile of the people located within a communication area of a certain base station, and information (user information) related to the user of terminal 14 that has performed transmission request of advertisements.

The base station 12 controls radio communication with the terminal 14, and the installation position of the base station 12 is registered in the base station control center 10. Therefore, the position of the terminal 14 that is located within the communication area of each base station 12 is detected on the basis of the installation position of the base station 12.

The terminal 14 controls radio communication with the base station 12, and it is formed of the PHS terminal. In the present embodiment, it is described as PHS terminal but it may also be other mobile communication terminals so long as they adopt a communication system of the cellular system having a position registering function. Each of the terminals 14 is given with a specific terminal number. The users of the terminals 14 that is located within the communication area of each base station 12 can be discriminated by distinguishing this terminal number through the base station control center 10.

The advertisement server 20 that is a device for providing the information controls the advertisement display in the advertisement unit (mobile type advertisement device 30 or fixed type advertisement device 32) that is located in the communication area which is controlled by the base station control center 10 via the base station 12, or the individual advertisement provision to the terminal 14 that is located in the communication area which is controlled by the base station control center 10 via the base station 12. The advertisement server 20 includes a contents control database 20a, advertisement data 20b, and advertisement effect control database 20c.

The contents control database 20a registers and controls the advertising contents provided by the advertiser (sponsor). The advertising contents received from the advertiser system 24 used by the advertiser via the communication network 22 can be registered in the contents control database 20a.

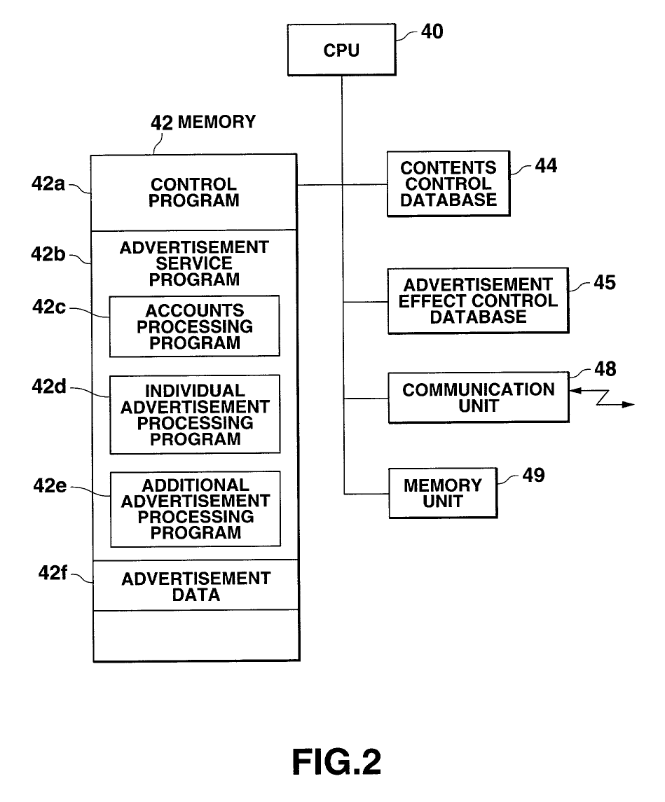

FIG. 2 is a block diagram showing the configuration of the advertisement server 20. This advertisement server 20 is realized by a computer which reads the program recorded in the recording medium and its operation is controlled by this program.

A CPU 40 controls the whole system. Various functions are realized on the basis of the programs and data stored in a memory 42. In the present embodiment, by executing an advertisement service program 42b, an advertisement can be provided to the advertisement unit (mobile type advertisement device 30 or fixed type advertisement device 32) and the terminal 14 both of which are intended for the people that is located in the communication area of a predetermined base station 12.

The memory 42 is a memory device of which data can be read or written by the CPU 40, and stores programs and data. In the present embodiment, the memory 42 stores an advertisement service program 42b in addition to a control program 42a for controlling the basic functions of the advertisement server 20.

The advertisement service program 42b includes programs such as an account processing program 42c for conducting account processing, individual advertisement processing program 42d for conducting individual advertisement processing, and additional advertisement processing program 42e for conducting additional advertisement processing. Detailed operation of each process shall be described below. The memory 42 further stores as advertisement data 42f (20b of FIG. 1), advertisement contents data to be provided and data showing the advertisement to be output and displayed.

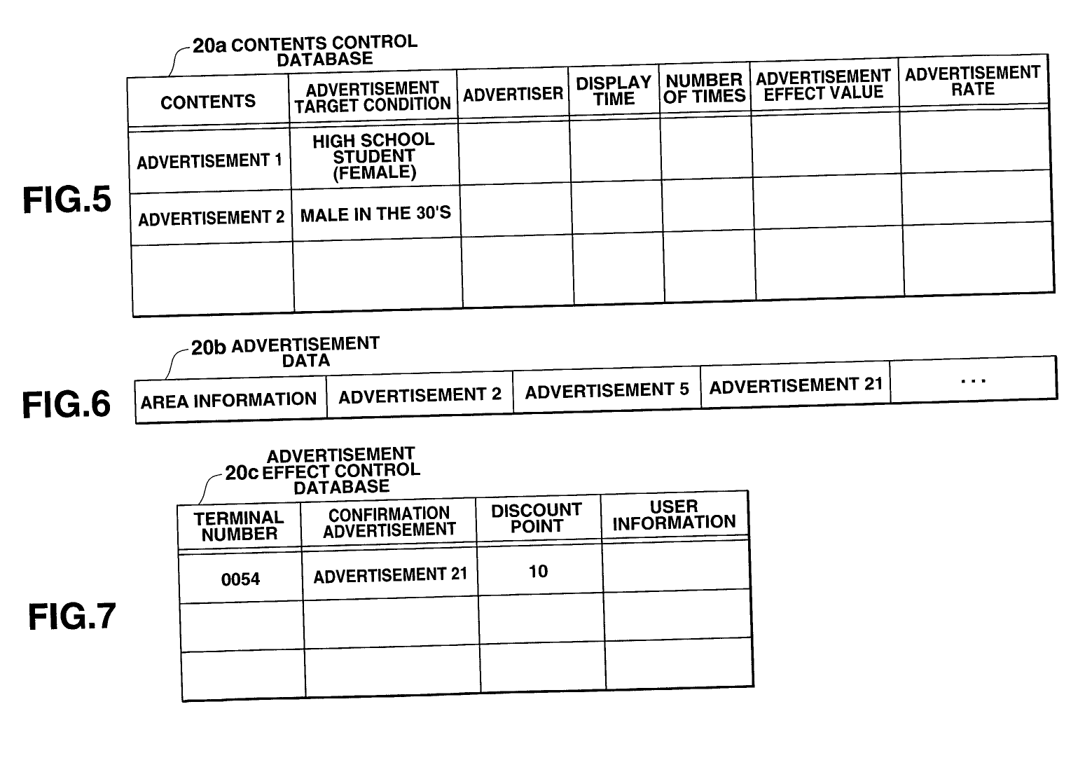

A contents control database 44 (20a of FIG. 1) controls the advertisement contents provided by the advertiser. As shown in FIG. 5 described below, together with the advertisement contents data, various data relating to the advertisement contents data are registered in the database 44.

An advertisement effect control database 45 (20c of FIG. 1) registers data related to advertisement effect as a result of provision of advertisement. As shown in FIG. 7 described below, various data are registered in the database 45.

A communication unit 48 is a device for conducting communication via the ISDN or leased line (internet).

A storage device 49 is a unit for storing various programs (the control program 42a, advertisement service program 42b, etc.) and various data. The programs that are recorded in the recording medium of the storage device 49 are read on the memory 42 as required, and various functions are realized by executing them.

The communication network 22 (referring to FIG. 1) is a communication route for mutually connecting the base station control center 10, advertisement server 20, advertiser system 24, etc., and it also includes various communication routes such as public line networks like ISDN as well as internet.

The mobile type advertisement device 30 includes a large-scale display screen loaded on to a truck, and it can be used by moving it to an arbitrary place such as train stations where people gather, or various event sites. The mobile type advertisement device 30 stores the advertising contents data (the same as the ones stored in the contents control database 20a of the advertisement server 20) for advertisement display, and has a function for displaying and outputting the corresponding advertisement contents by indicating the advertisement, or a function for receiving and displaying the advertisement contents data provided from the advertisement server 20 by radio communication. In other words, the mobile type advertisement device 30 has a receiving function similar to the terminal 12.

The fixed type advertisement device 32 has a large size display screen that is installed by fixing it to buildings, baseball grounds, athletic fields, and various other places. The fixed type advertisement device 32 has a display and output function for receiving advertisement contents data from advertisement server via wire and radio networks. In other words, the fixed type advertisement device 32 has a receiving function similar to the terminal 12.

Next, an explanation is given to the outline of data controlled by the base station control center 10 and advertisement server 20.

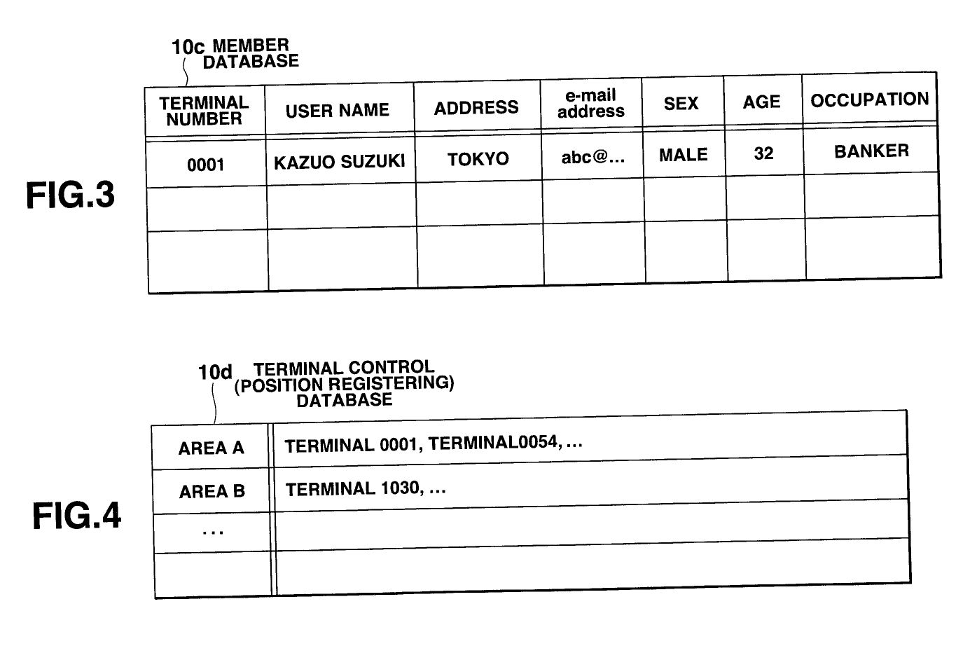

FIG. 3 shows an example of data configuration of the member database 10c controlled by the base station control center 10. The information registered in the member database 10c is provided by the contractor at the time the usage contract of the terminal 14 is made, and in correspondence with the terminal number for distinguishing the terminal 14, specific information such as user name, address, E-mail address, and attribute information such as distinction of sex, age, and occupation are registered.

FIG. 4 shows the data configuration of the terminal control (position registration) database 10d which controls data registration by the terminal position registration section 10a. The terminal 14 located in each area corresponding to a plurality of base stations 12 is detected and the terminal number that indicates such terminal is registered in the terminal control (position registration) database 10d.

FIG. 5 shows an example of data configuration of the contents control database 20a. The contents control database 20a registers the advertisement contents provided by the advertiser, together with the advertisement target conditions that show the targets to which the advertisement is to be provided, and the data regarding the advertiser. Furthermore, in order to control the advertisement transmitting conditions, the advertisement providing display time, display frequency, advertisement effect value, and advertisement expenses accompanying the transmission of the advertisements are registered. Moreover, the details will be described below.

As shown in FIG. 6, the advertisement data 20b indicates the advertisement data to be output by an advertisement unit (mobile type advertisement device 30, fixed type advertisement device 32) or advertisement contents to be output by the terminal 14 and may be the advertisement contents data itself, or if the advertisement contents data are stored beforehand such as in the mobile type advertisement device 30, it may be data that indicates the advertisement contents to be displayed and output. Furthermore, the advertisement data 20b can add area information of the provision destination area so that provision of advertisement can be made to a specified area.

The advertisement effect control database 20c stores data related to the advertisement effect as a result of the provision of advertisement as shown in FIG. 7. For example, the terminal number of the terminal 14 which notified that the advertisement is seen, and the advertisement contents that were displayed at the time the notification is made, in other words, the data indicating that the advertisement contents which have been confirmed are registered. In addition, discount points for making returns to users who have seen the advertisement, and user information related to the users are registered. Details will be described below.

Next, an explanation will be given on the operation of the advertisement system in the present embodiment.

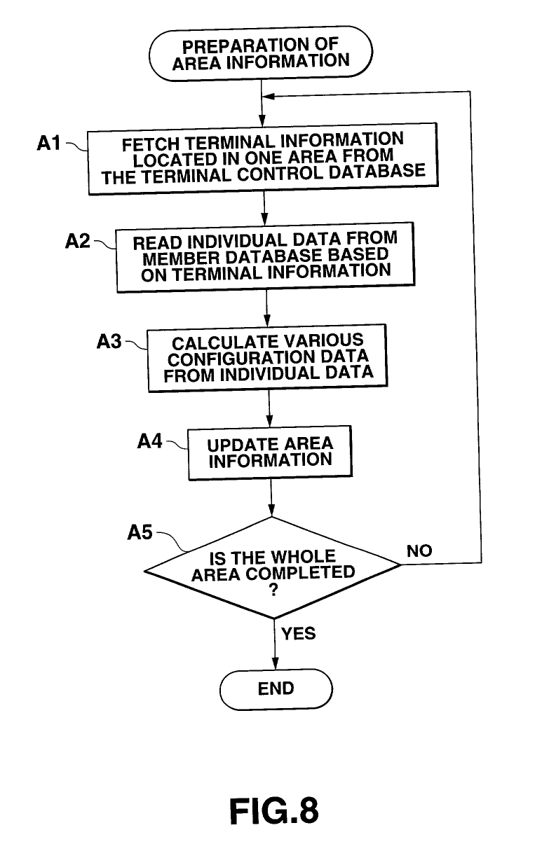

First, an explanation will be given on the area information preparation process in the base station control center 10 by referring to the flow chart shown in FIG. 8.

The terminal position registering section 10a always detects the terminal 14 located within the area corresponding to each base station by using the position registration function of the mobile telephone system. The terminal position registering section 10a registers the terminal number showing the terminal 14 located in each area to the terminal control (position registration) database 10d for each area. In the example shown in FIG. 4, it is registered that in area A, terminals 14 of the terminal numbers 0001, 0054, etc. are located, and in area B, the terminal 14 of the terminal number 1030 is located.

The terminal control section 10b conducts area information preparation process periodically. In this processing, terminal information located in a certain area, for example, terminal information registered in area A is taken out from the terminal control (position registration) database 10d (step A1). Next, the terminal control section 10b reads the corresponding individual data on the terminal information located in area A from the member database 10c (step A2). In case the terminal number registered in terminal control (position registration) database 10d is 0001, all data (user name, address, . . . ) that correspond to the terminal number 0001 registered in the member database 10c are read out.

The terminal control section 10b calculates each configuration data based on the individual data taken from the member database 10c (step A3). Configuration data is data that indicates what sort of people the users of terminal 14 located in the area are, and comprises statistical data analyzed on the basis of attribute information of the users. For example, data such as age configuration ratio, sex configuration ratio, and occupation configuration ratio are included. The terminal control section 10b updates the area information regarding the area based on the various configuration data that have been analyzed (step A4). As statistical data that become the target of analysis, the values of the total, average, or standard deviation of people by age may be used.

The above-mentioned processing is performed for each area registered in the terminal control (position registration) database 10d (steps A1-A5). Therefore, analysis information showing what kind of people is located in each area at the present time can be detected on the basis of the area information (configuration data).

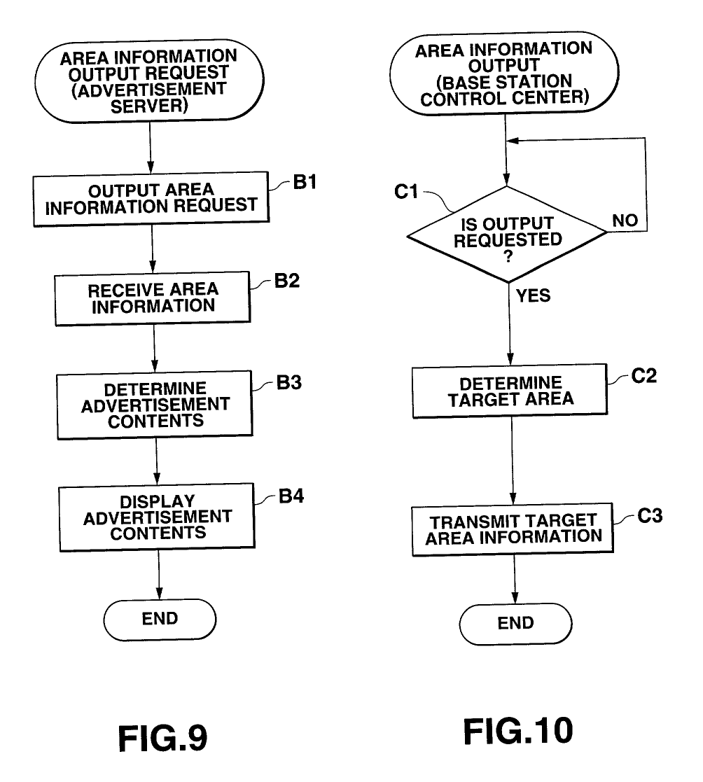

Next, an explanation will be given on the processing accompanying advertisement provision based on advertisement server 20 by referring to the flow chart shown in FIG. 9 to FIG. 11.

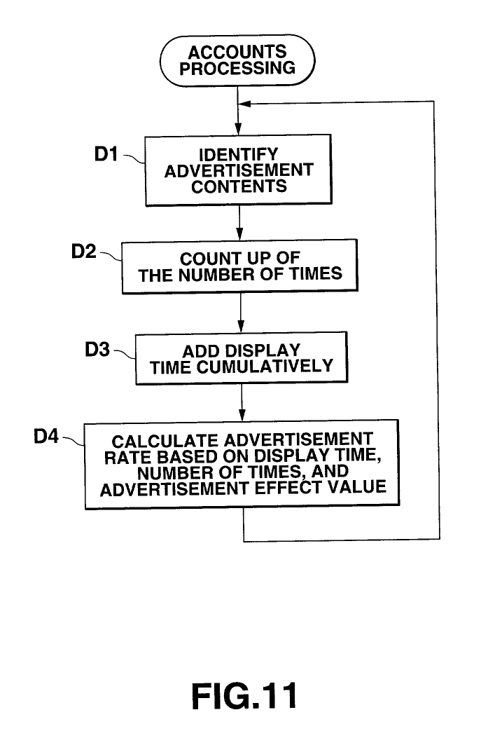

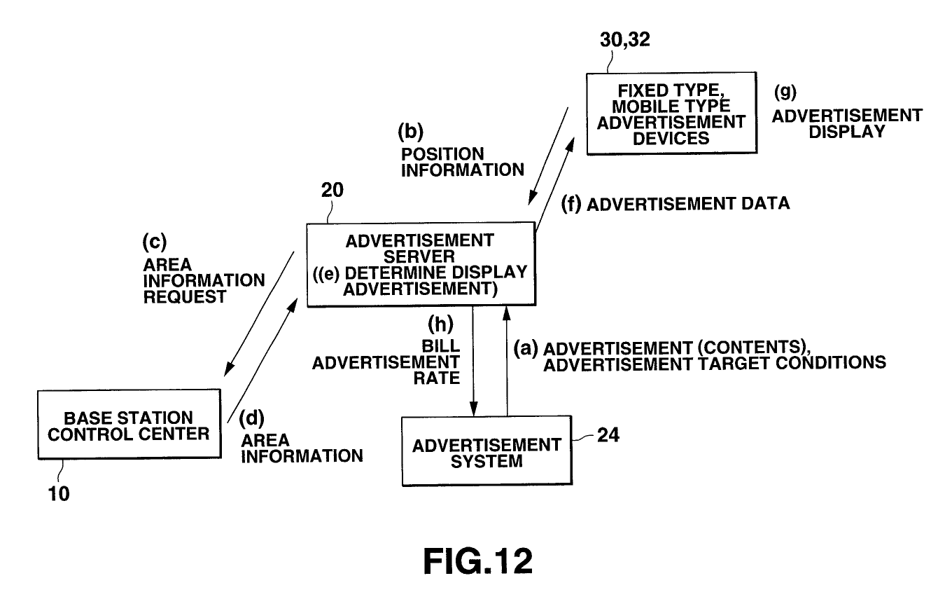

FIG. 9 shows area information output request processing in the advertisement server 20, FIG. 10 shows area information output processing in the base station control center 10, and FIG. 11 shows account processing in the advertisement server 20. FIG. 12 shows the flow of information in each section included in the system.

The advertisement which is provided by the advertisement server 20, is prepared by the advertiser, beforehand. The advertiser system 24 notifies the advertisement server 20 the “advertisement contents” and the “advertisement target conditions” that show to what sort of people one wishes to provide these advertisement contents ((a) of FIG. 12). The advertisement server 20 registers the advertisement contents and the advertisement target conditions from the advertiser system 24 to the contents control database 20a. The advertisement contents may be provided from the advertiser system 24 to the advertisement server 20 via the communication network 22, or it may be provided through a different form.

The advertisement server 20 requests to the base station control center 10 the area information of the area in which the fixed type advertisement device 32 is installed if the advertisement is transmitted in the fixed type advertisement device 32, and the area information of the area in which the mobile type advertisement device 30 is located if the advertisement is output in the mobile type advertisement device 30. (step B1 of FIG. 9, (c) of FIG. 12). It is desirable to issue this request periodically.

The position of the mobile type advertisement device 30 is detected by utilizing the function of the position detection based on the base station control center 10 by loading the terminal 14 to the mobile type advertisement device 30, or the mobile type advertisement device 30 conducts the position detection independently by such means as GPS (Global Positioning System). The position information is notified to the advertisement server 20 by the communication line or radio via the base station control center 10 ((b) of FIG. 12).

If the area information corresponding to the specified position where the advertising device 30 or 32 is located is requested by the advertisement server 20, the base station control center 10 judges the target area (steps C1, C2 in FIG. 10), and transmits the area information corresponding to that area to the advertisement server 20 via the communication network 22 (step C3 of FIG. 10, (d) of FIG. 12). The area information includes configuration data that analyzes what sort of people there are in the users of the terminal 14 located in the area.

When the advertisement server 20 receives the area information (step B2 of FIG. 9), the advertisement contents displayed on the basis of the configuration data included in it are determined (step B3 of FIG. 9, (e) of FIG. 12). For example, if the configuration data shows that many males in their thirties are located in the that area, the advertisement target conditions of the contents control database 20a is searched for, and if the corresponding conditions exist (i.e. males in their thirties), the advertising contents corresponding to it are determined as the advertising contents to be the target of display. In the case of the example shown in FIG. 5, since “advertisement 2”, corresponds to the area information indicating the males in their thirties, it will become the advertisement contents intended for display. Furthermore, in step B3, the advertisement content is not determined as being one, and the order of priority is given to a plurality of determined contents, and it is desirable to select one of the advertisement contents according to the order of priority.

The advertisement server 20 transmits the advertisement contents as advertisement data 20b to the fixed type advertisement device 32 or mobile type advertisement device 30 to be displayed (step B4 of FIG. 9, (f) of FIG. 12).

Next, an explanation will be given on the account processing by the advertisement server 20 with reference to the flow chart shown in FIG. 11. Accounts processing is realized by processing of the provision of advertisement contents based on the above-mentioned area information output request processing, together with the execution of the account processing program 42c.

The advertisement server 20 identifies the advertisement contents provided based on the area information output request processing (step D1). The advertisement server 20 counts up the number of times the contents are displayed which is stored in the contents control database 20a corresponding to the provided advertisement contents (step D2). The display time is added cumulatively in accordance with the time the advertisement is displayed by the provision of the advertisement contents (step D3).

The advertisement server 20 calculates the advertising rate on the basis of display time and the number of times the contents are displayed that are updated based on the provision of advertisement contents, and registers them to the contents control database 20a (step D4). The advertisement effect values shown in FIG. 5 and FIG. 11 are used in the account processing corresponding to the processing mentioned below (details thereof will be described below).

The above-mentioned processing is performed for each advertisement contents each time the advertisement contents are provided. The advertisement server 20 transmits the rate data to the advertiser system 24 via the communication network 22 at the specified timing, for example, at the end of the advertisement period designated by the advertiser or at each specified period (end of the month, etc.), and billing of the advertisement rate is made to the advertiser ((h) of FIG. 12).

In this way, the base station control center 10 generates and provides data (area information) based on a result of analysis of the information related to the people located in a specified area based on the position information of the terminal and the attribute information of the users possessed by the terminal. On the other hand, since the advertisement server 20 selects and provides the advertisement contents related to each area based on the area information (configuration data) regarding each communication area obtained from the base station control center 10, it conducts the advertisement efficiently versus the advertisement target that the advertisers request. Even if the mobile type advertisement device 30 moves to an arbitrary position, it is possible to display a suitable advertisement to the communication area of the place the unit moves to. Moreover, since the advertisement rate is determined in accordance with the number of times the contents are displayed and display time of the advertisement contents, the advertisement effect can be optimized, and the advertisers need not spend an unnecessary advertising rate.

Next, an explanation will be given on the case in which the advertisement is output and displayed in the terminal 14. In the above-mentioned explanation, the advertisement is provided to many and unspecified persons by mobile type advertisement device 30 or fixed type advertisement device 32, but in this case, by displaying the advertisement in an individual terminal 14, the party to which the advertisement is intended is narrowed down even more, and an effective advertisement can be made.

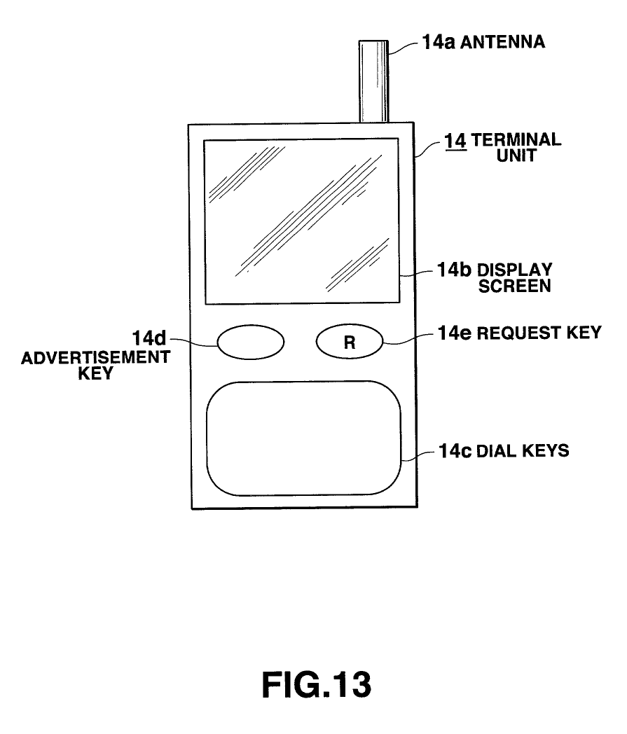

The terminal 14 used in this case is assumed to be a cellular telephone having an appearance, for example, as shown in FIG. 13.

In other words, the terminal 14 comprises a display screen 14b, dial key 14c, etc., in addition to an antenna 14a for radio communication. Furthermore, the terminal 14 comprises an advertisement key 14d for requesting an advertisement to the advertisement server 20, and a request key 14e to make special request for the contents of the advertisement. The advertisement key 14d and the request key 14e may be basically provided to a specified key or a combination of a plurality of keys installed to the dial key 14c.

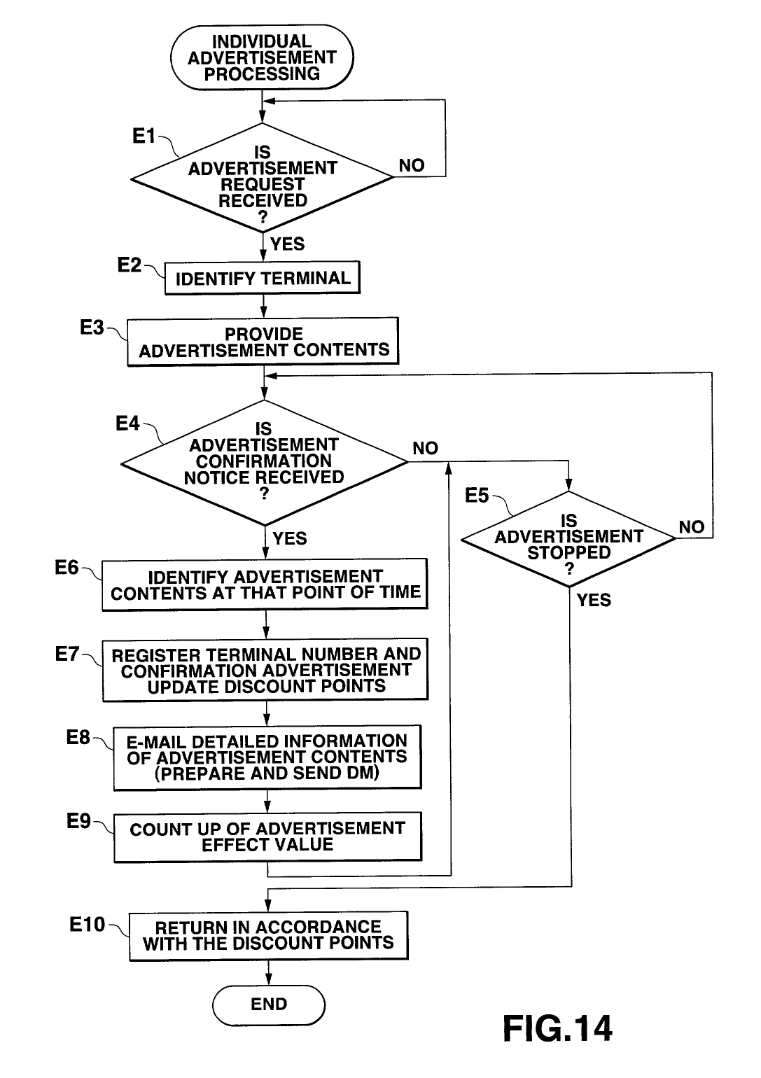

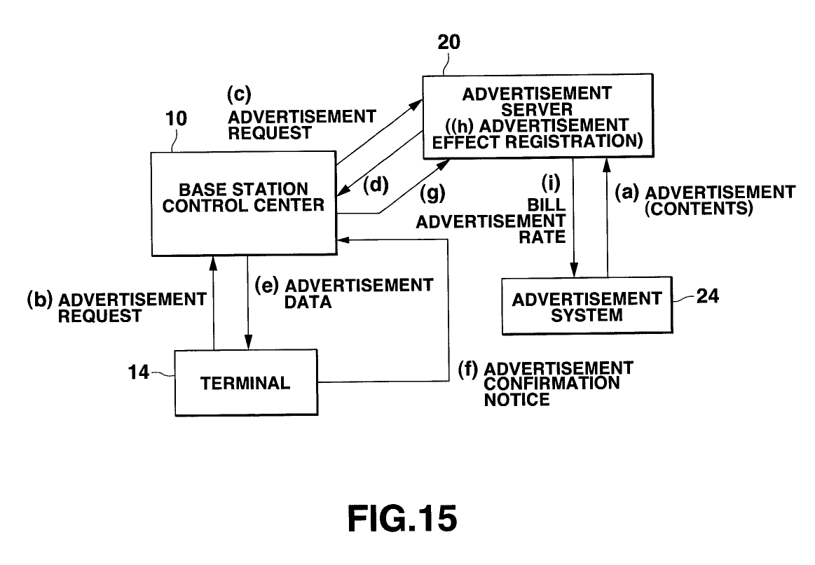

FIG. 14 shows the flow chart of individual advertisement processing in the advertisement server 20. FIG. 15 shows the flow of information in each section included in the system.

In this case also, the advertisement contents provided from the advertisement server 20 are prepared by the advertiser system 24, beforehand ((a) of FIG. 15). If the advertisement key 14d is pressed in the terminal 14, the terminal 14 enters a mode in which the advertisement is received and displayed, and at the same time transmits the advertisement request to the base station control center 10 via the base station 12 of the communication area that it is located in ((b) of FIG. 15). When the base station control center 10 receives the advertisement request, the base station control center 10 notifies the advertisement request to the advertisement server 20 via the communication network 22 together with the terminal number that indicates the terminal 14 for which the request is made ((c) of FIG. 15).

When the advertisement server 20 receives the advertisement request (step El of FIG. 14), the advertisement server 20 identifies the terminal 14 that made the advertisement request based on the terminal number from the base station control center 10 (step E2). The advertisement server 20 provides the advertisement contents (advertisement data) to the terminal 14 to which advertisement request is made via the communication network 22 and base station control center 10 (step E3, (d), (e) of FIG. 15).

The advertisement contents that are provided here may be those prepared for providing beforehand in the advertisement server 20, and if the user information is obtained together with the terminal number from the base station control center 10, based on the information such as the distinction of sex, age, occupation, etc. included in the user information, the advertisement target conditions of the contents control database 20a are searched for by utilizing them in a similar way to the configuration data mentioned above. The advertisement contents intended for the providing are selected. For example, if information that the user of the terminal 14 is a male in the thirties is obtained from the base station control center 10, based on this data, the advertisement target conditions of the contents control database 20a are searched, and if any conditions which correspond exist (“Advertisement 2” of FIG. 5), the corresponding advertisement contents are selected as transmission target. In addition, even if advertisement server 20 cannot obtain user information from base station control center 10, only the advertisement contents corresponding to each user can also be selected and provided.

In this way, if the terminal 14, by pressing the advertisement key 14d, the advertisement contents are displayed in order in the display screen 14b. Provided, however, that if only the advertisements are merely displayed on the display screen 14b, there is possibility that the users will not pay attention to the advertisement. Thus, in the system of the present embodiment, by pressing the advertisement key 14d again, at the specified timing in relation to the advertisement contents displayed in the display screen 14b, points are given to the user of the terminal 14. These points can be utilized, for example, for discounts of communication rate or shopping (EC: Electronic Commerce) via the internet. By doing so, it promotes the users to pay attention to the advertisements. Furthermore, the giving of points need not be done limitlessly, and they may be limited by specified conditions.

When a certain advertisement is displayed in the terminal 14, if the advertisement key 14d is further pressed, the terminal 14 notifies the advertisement confirmation notice to the advertisement server 20 via the base station control center 10 ((f), (g) of FIG. 15). When the advertisement server 20 receives this advertisement confirmation notice (step E4), the advertisement contents that have been provided are identified (step E6), the terminal number that indicates the terminal 14 from which the advertisement confirmation notice has been transmitted, and the data showing the confirmed advertisement as well as the discount points are made to correspond with one another, and registered in the advertisement effect control database 20c (step E7). Therefore, in the advertisement effect control database 20c the data that indicate confirmed advertisements are registered in order, and at the same time, the discount points are updated.

Furthermore, among a plurality of advertisements that have been provided to the terminal 14, for the advertisements that have clearly made advertisement confirmation notice, the advertisement server 20 deems that the users showed special interest and sends, for example, electronic mail of the detailed information of the advertisement contents (step E8), changes the contents of the advertisement contents to be displayed in the display screen 14b to detailed contents, and freezes them. In addition, if information regarding the user of the terminal 14 that has performed advertisement confirmation notice, for example, the user name, address, etc., are obtained together with the advertisement confirmation notice from the base station control center 10, the advertisement server 20 also registers these user information in the advertisement effect control database 20c. Moreover, based on such user information, detailed information of the advertisement contents is transmitted by other means such as a direct mail (DM).

Furthermore, the advertisement server 20 counts up the advertising effect values of the contents control database 20a, corresponding to the advertisement contents for which the advertisement confirmation notices were made (step E9, (h) of FIG. 15).

In a similar way, the advertisement contents are provided in order, and if advertisement confirmation notice is made, while updating the discount points, and conducts a processing to transmit the detailed information of the corresponding advertisement contents. If a notice for stopping the advertisement is made (step E5), the advertisement server 20 conducts restoration such as discount of the communication rate for the users or conversion of the information to the information usable in EC (Electronic Commerce) (step E10).

By account processing (FIG. 11), the advertisement server 20 calculates the advertisement rate based on the display time of the contents control database 20a, a number of times the contents are displayed, and advertisement effect values, then bills the advertiser at the specified timing similar to the above-mentioned method ((i) of FIG. 15).

In this way, by conducting returns such as discount points to the users by letting the users conduct specified operations and displaying the reception of advertisement such as operating the advertisement key 14d in the terminal 14, the users can be made to observe the advertisement positively. In addition, since it can be clearly determined from the receiving of advertisement confirmation notice that the advertisement attracted the attention of the users, the advertisement rate can be determined in accordance with the results (advertisement result value), and it is possible to bill a suitable rate corresponding to the advertisement effect to the advertiser. Furthermore, since an effective advertising effect versus the advertisement rate can be obtained for the advertiser as well, it will become easier to make requests of advertisement providing for the advertisement server 20.

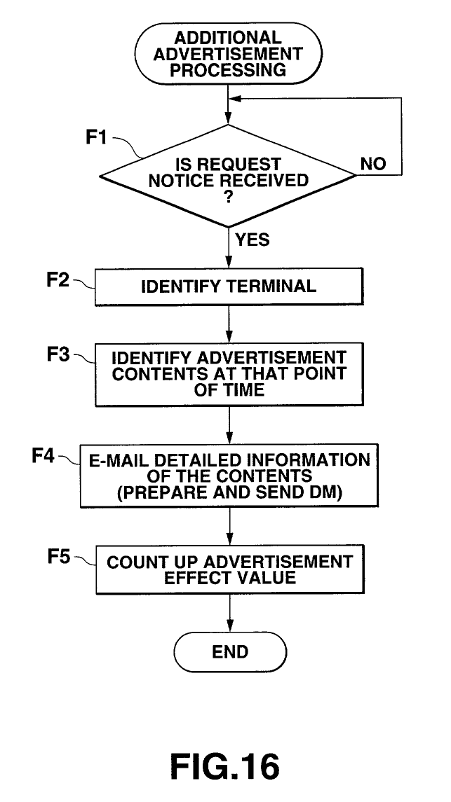

Next, an explanation will be given on the additional advertisement processing in the advertisement server 20 by referring to the flow chart shown in FIG. 16.

In this case, the advertisement is for promoting the users to purchase the advertised goods positively. As for this information providing, it may be providing to many and unspecified persons by the aforementioned mobile type advertisement device 30 or fixed type advertisement device 32, or individual advertisement providing in which advertisement contents are provided to terminal 14.

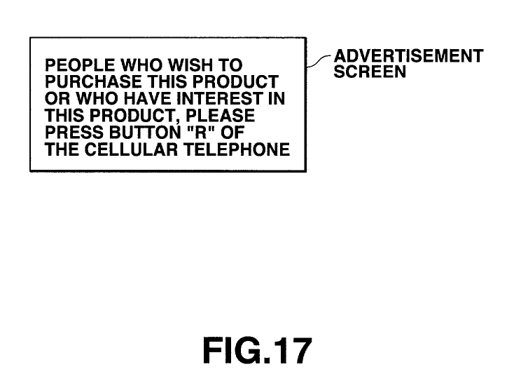

The advertisement server 20 periodically provides a plurality of advertisement contents, and at the same time inserts information promoting purchase of the goods introduced by the advertisement as shown in FIG. 17 to the providing contents.

When a certain advertisement content is displayed in the advertising devices 30 and 32, if a person who saw the purchase promoting message of FIG. 17 presses the request key 14e of the terminal 14 that the person possesses, the terminal 14 notifies the request to the advertisement server 20 via the base station control center 10. The advertisement server 20 receives the request notice together with the terminal number of the terminal 14 that made the request (step F1). Subsequently, the advertisement server 20 identifies the terminal 14 that made the request notice (step F2), and determines the advertisement contents that are being provided at that time (step F3).

In other words, in relation to the advertisements to which request notices were clearly made among the advertisements being provided, the advertisement server 20 provides that user with detailed information of the advertisement contents individually, for example, by an electronic mail (step F4) based on the assumption that the user desires to make a purchase or that the user has special interest in it. If the advertisement server 20 obtains information related to the user of the terminal 14 that performed the advertisement confirmation notice, for example, user name, address, etc., together with the advertisement notice from the base station control center 10, these user information are also registered in the advertisement effect control database 20c. Based on such user information, detailed information of the advertisement contents is transmitted by other means such as a direct mail (DM). In the detailed information, not only the details of the advertisement contents but also formats for placing purchase orders are included so that the user can easily place orders for the purchase of the goods.

The advertisement server 20 counts up the advertisement effect value (step F5) of the contents control database 20a corresponding to the advertisement contents of which advertisement confirmation notice is made.

In this way, since not only the provision of advertisements but also positive promotion of purchase for the goods can be made at the same time, the advertisement providing can be utilized most effectively.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

In addition, in the explanation mentioned above, though the data to be provided is described as the advertisement contents, this may be speech data. It is possible to output the sound from the mobile type advertisement device 30, fixed type advertisement device 32, or the terminal 14 in addition to display the advertisement contents.

Furthermore, in the above-mentioned explanation, the base station control center 10 (communication company) and the advertisement server 20 (advertisement providing company) are located independently, but the two may be formed as one.

Moreover, in the above-mentioned explanation, the base station control center 10 utilizes a small zone radio communication system such as the PHS, but if it has a position registering function that always detects in what position of the control area (communication area) of the base station the mobile terminal is located, it may be a system that utilizes radio communication system other than the PHS.

In addition, the various processing performed in the aforementioned embodiment can be realized by executing the program stored in the recording medium. The recording medium is formed of magnetic, optical recording medium, or semiconductor memory and can be provided as ones fixed to the recording unit, or ones that can be mounted or demounted freely. Furthermore, the program and data that are recorded in the recording medium may receive from other equipment connected via the communication circuits. In addition, a recording unit equipped with recording medium is installed to other equipment side connected via the communication circuits, and it may be made into a configuration where program and data recorded in the aforementioned recording medium are used via the communication circuit.

What is claimed is:

1. An information providing system for providing information to a display device located in a specified area, the system comprising:
a memory configured to store a plurality of items of information;
an analyzer configured to analyze information related to a user of a mobile terminal located in the specified area;
a selector configured to select an item or items of information among the plurality of items of information stored in said memory based on a result of analyzing by said analyzer; and
a providing circuit configured to provide the item or items of information selected by said selector to said display device.

2. The system according to claim 1, wherein said display device comprises a screen which is installed to public places so that many and unspecified people can see.

3. The system according to claim 1, which further comprises:
a database configured to store user information containing at least a distinction of sex, age, and occupation of the user;
an identification circuit configured to identify said mobile terminal located in the specified area; and
a fetching circuit configured to fetch the user information of the user of the mobile terminal identified by said identification circuit from said database, and wherein said analyzer statistically analyzes the user information fetched by said fetching circuit.

4. The system according to claim 1, wherein said providing circuit provides advertising information.

5. A mobile terminal control apparatus comprising:
a database configured to store user information related to a user of a mobile terminal;
an identification circuit configured to identify a mobile terminal located in a specified area;
a reading circuit configured to read a user information of the mobile terminal identified by said identification circuit from said database; and
an output circuit configured to output the user information read by said reading circuit.

6. The apparatus according to claim 5, wherein the user information includes at least a distinction of sex, age, or occupation of the user, and said output circuit comprises an analyzer configured to statistically analyze the user information read by said reading circuit.

7. The apparatus according to claim 6, wherein said identification circuit identifies the mobile terminal by using a position registering function of a mobile telephone system.

8. The apparatus according to claim 7, wherein said output circuit outputs the user information read by said reading circuit to an advertisement providing device advertises to the specified area.

9. An information providing apparatus comprising:
a memory configured to store a, plurality of items of information;
a fetching circuit configured to fetch an analysis information of a user of a mobile terminal located in a specified area;
a selector configured to select an item or items of information among the plurality of items of information stored in said memory based on the analysis information fetched by said fetching circuit; and
a providing circuit configured to provide the item or items of information selected by said selector to the display device located in the specified area.

10. The apparatus according to claim 9, wherein said display device comprises a screen which is installed to public places so that many and unspecified people can see.

11. The apparatus according to claim 9, wherein the information stored in said memory is an advertising information.

12. The apparatus according to claim 9, further comprising:
a detector configured to detect that the mobile terminal located in the specified area outputs a predetermined signal;
an identifying circuit configured to identify an information displayed by the display device when the predetermined signal is output; and
an information transmitter configured to transmit a detailed information related to the information identified by said identifying circuit to a user of the mobile terminal that outputs the predetermined signal.

13. The apparatus according to claim 9, further comprising an account circuit configured to calculate a rate for provision of the information selected by the selector.

14. A method of providing information to a display device located in a specified area by using a mobile terminal control apparatus controlling mobile terminals located in each area, the method comprising:
writing into a memory a plurality of items of information to be provided to the display device;
analyzing information related to a user of a mobile terminal located in the specified area;
selecting an item or items of information among the plurality of items of information stored in the memory based on a result of analyzing; and
providing the item or items of information selected to said display device.

15. The method according to claim 14, wherein said display device comprises a screen which is installed to public places so that many and unspecified people can see.

16. The method according to claim 14, further comprises:
registering user information containing at least a distinction of sex, age, and occupation of a user of the mobile terminals into a database;
identifying the mobile terminal located in the specified area;
fetching the user information of the user of the identified mobile terminal; and
statistically analyzing the fetched user information.

17. The method according to claim 14, wherein the provided item or items of information is an advertising information.

18. The method according to claim 14, further comprising:
detecting that the mobile terminal located in the specified area outputs a predetermined signal;
identifying an information displayed by the display device when the predetermined signal is output; and
transmitting a detailed information related to the identified information to a user of the mobile terminal that outputs the predetermined signal.

19. The method according to claim 14, further comprising calculating a rate for provision of the selected information.

20. An article of manufacture comprising a computer usable medium having computer readable program code means embodied therein, the computer readable program code means comprising:
a computer readable program code for causing a computer to fetch an analyzed information of a user of a mobile terminal located in a specified area;
a computer readable program code for causing a computer to select an item or items of information among a plurality of items of information stored in a database based on the fetched analyzed information; and
a computer readable program code for causing a computer to provide the selected item or items of information to a display device located in the specified area.
